(19) United States
(12) Patent Application Publication
(10) Pub. No.: US 2013/0289937 A1
(43) Pub. Date: Oct. 31, 2013

(54) COMPUTING DEVICE AND METHOD OF MEASURING SURFACE DIMENSIONS OF OBJECTS

(71) Applicants: HONG FU JIN PRECISION INDUSTRY (ShenZhen) CO., LTD., (US); HON HAI PRECISION INDUSTRY CO., LTD., New Taipei (TW)

(72) Inventors: CHIH-KUANG CHANG, New Taipei (TW); XIN-YUAN WU, Shenzhen (CN); LU YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/863,424

(22) Filed: Apr. 16, 2013

(30) Foreign Application Priority Data
Apr. 28, 2012 (CN) 201210132116.1

(51) Int. Cl. G06F 17/50

(52) U.S. Cl. CPC G06F 17/5009
USPC 702/155

(57) ABSTRACT

In a method for measuring surface dimension of an object, an enclosing box of a triangular mesh surface of the object is constructed, and divided into sub-boxes. Relationships between the triangles and the sub-boxes are generated according to intersections. A measuring point is selected, and coordinates and a searching vector of the measuring point are obtained. A ray, which starts from the selected measuring point along the direction where the searching vector is directed to, is constructed, and sub-boxes intersecting with the ray are obtained sequentially. One of the obtained sub-boxes is selected and triangles which intersect with the selected sub-box are obtained. An intersection point of the ray and one of the obtained triangles, and a vector of the obtained triangle are recorded into a measuring file. Measurements on the surface of the object are implemented according to the measuring file.

### BACKGROUND

1. Technical Field

Embodiments of the present disclosure relate to image measuring techniques, and more particularly to a computing device and a method of measuring surface dimension of an object.

2. Description of Related Art

During the measurement of surface dimension of an object using a three-dimensional (3D) measurement machine, points on the surface are contacted by a probe of the 3D measurement machine. Usually, the 3D measurement machine is controlled by an operator. The operator cannot know vector coordinates of the different points contacted, thus, there may be some mistakes in picking the points, causing inaccurate measurement of the object.

### BRIEF DESCRIPTION OF THE DRAWINGS

FIG. 1 is a block diagram of one embodiment of a computing device including a surface measurement system.

FIG. 2 is a block diagram of one embodiment of function modules of the surface measurement system in FIG. 1.

FIG. 3A to FIG. 3C are flowcharts of one embodiment of a method for measuring surface dimension of an object.

FIG. 4 is a schematic diagram of an enclosing box.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

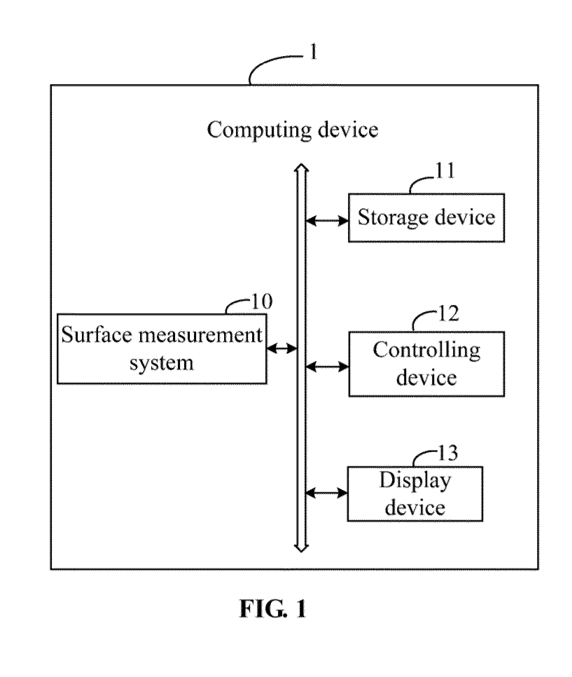

FIG. 1 is a block diagram of one embodiment of a computing device 1 including a surface measurement system 10. The computing device 1 may be a computer, a server, or a personal digital assistant (PDA), for example. The computing device 1 further includes a storage device 11, a controlling device 12, and a display device 13. One skilled in the art recognizes that the computing device 1 may be configured in a number of other ways and may include other or different components.

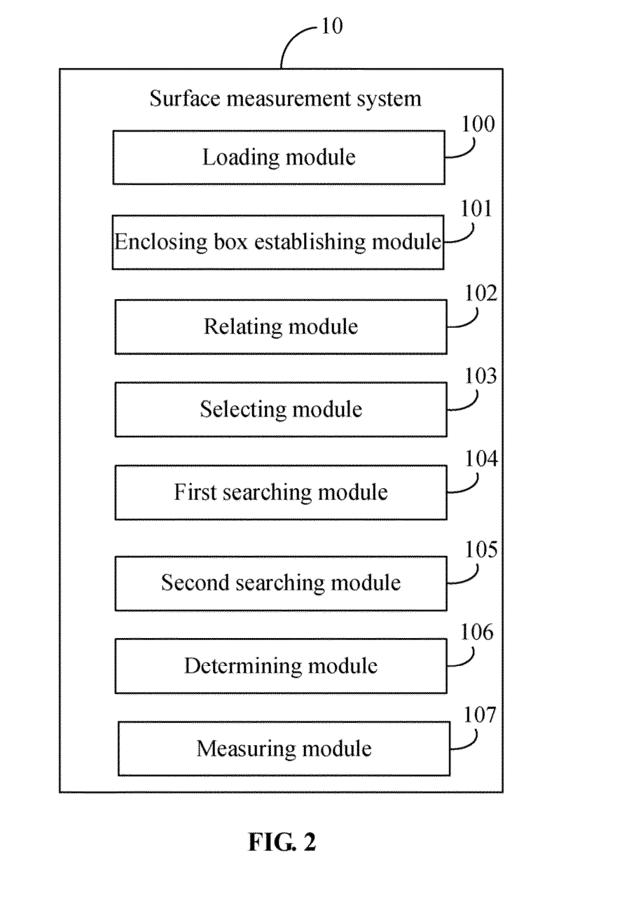

The surface measurement system 10 includes computerized codes in the form of one or more programs, which are stored in the storage device 11. In present embodiment, the one or more programs of the surface measurement system 10 are described in the form of function modules (see FIG. 2), which are executed by the controlling device 12 to perform functions of establishing a measuring file, which records points and vectors for measuring surface dimension of an object being measured.

The storage device 11 may include some type(s) of non-transitory computer-readable storage mediums, such as a hard disk drive, a compact disc, a digital video disc, or a tape drive. In one embodiment, the storage device 11 stores data needed when establishing the coordinate system on the surface of the object being measured.

The data may include, but is not limited to, a computer aided design (CAD) model of the object 3.

The controlling device 12 may be a processor, a microprocessor, an application-specific integrated circuit (ASIC), or a field programmable gate array, (FPGA) for example.

The display device 13 displays visible data such as the CAD model of the object being measured.

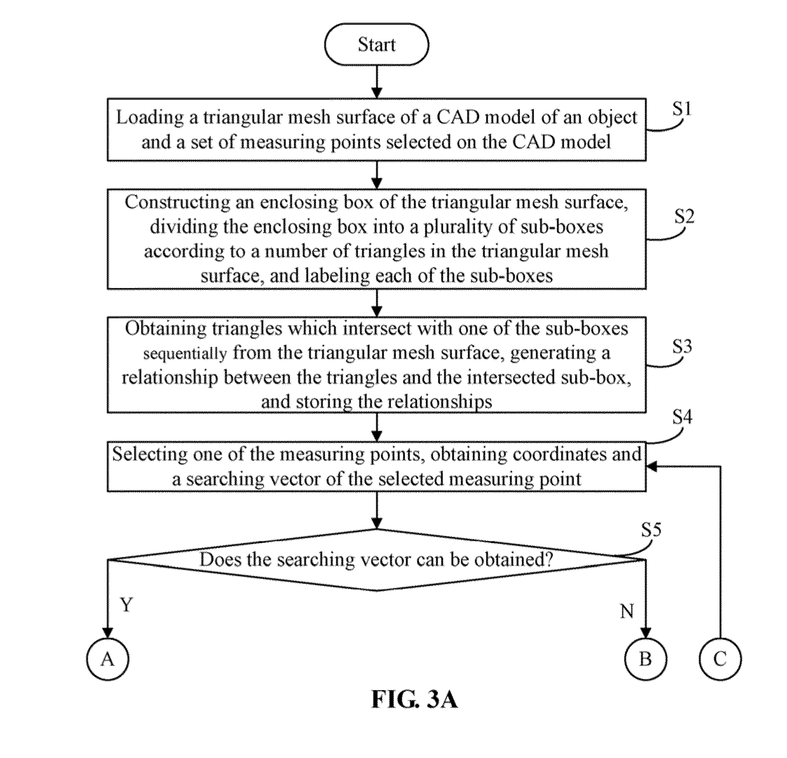

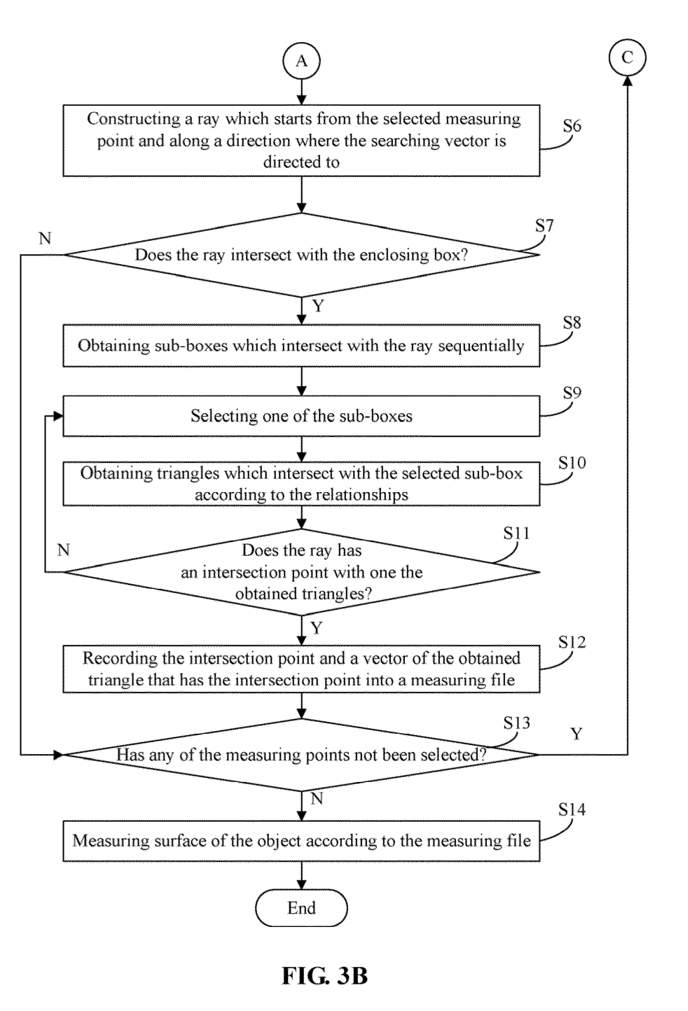

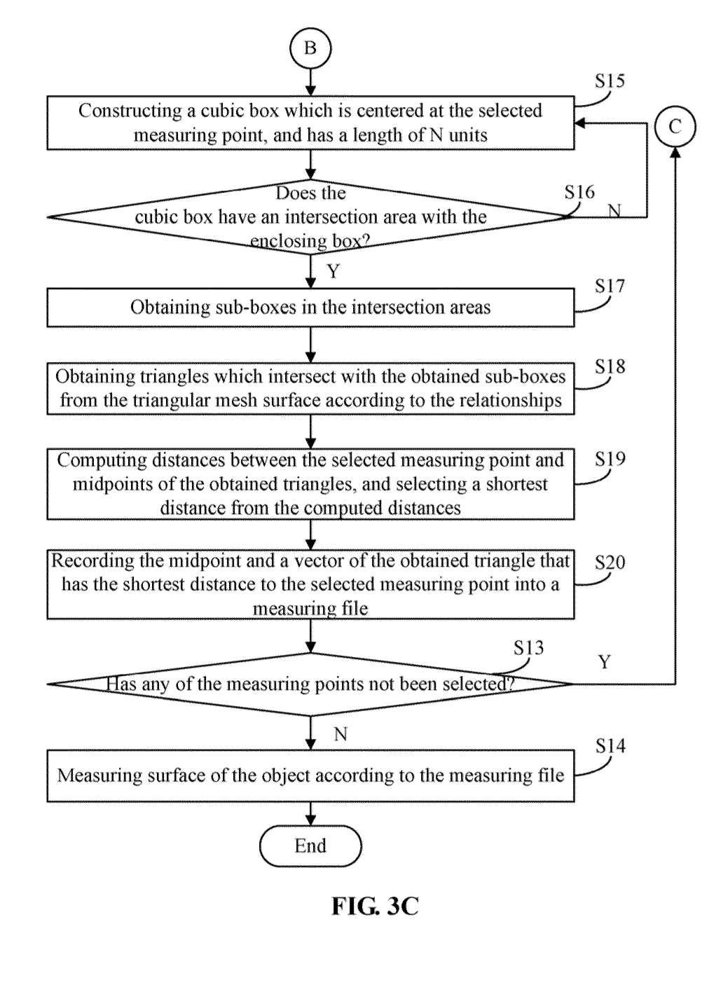

FIG. 2 is a block diagram of one embodiment of function modules of the surface measurement system 10 in FIG. 1. In one embodiment, the surface measurement system 10 may include a loading module 100, an enclosing box establishing module 101, a relating module 102, a selecting module 103, a first searching module 104, a second searching module 105, a determining module 106, and a measuring module 107. The function modules 100 to 107 provide at least the functions needed to execute the steps illustrated in FIGS. 3A to 3C below.

FIGS. 3A to 3C are flowcharts of one embodiment of a method for measuring surface dimension of an object. Depending on the embodiment, additional steps may be added, others removed, and the ordering of the steps may be changed.

Referring to FIG. 3A, in step S1, the loading module 100 loads a triangular mesh surface of a CAD model of the object and a set of measuring points selected on the CAD model. The triangular mesh surface is a surface which consist of a plurality of triangles.

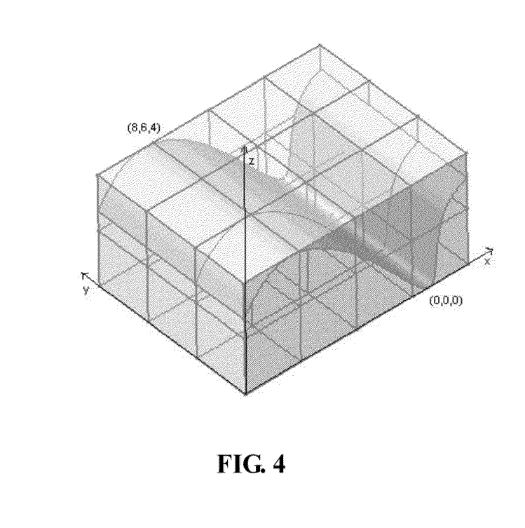

In step S2, the enclosing box establishing module 101 constructs an enclosing box of the triangular mesh surface, divides the enclosing box into a plurality of sub-boxes according to a number of the triangles in the triangular mesh surface, and labels each of the sub-boxes. In one embodiment, the enclosing box establishing module 101 obtains minimum coordinates (X1, Y1, Z1) and maximum coordinates (X2, Y2, Z2) of border points of the triangular mesh surface, and constructs the enclosing box using vertexes which respectively have coordinates of (X1, Y1, Z1), (X1, Y1, Z2), (X1, Y2, Z1), (X1, Y2, Z2), (X2, Y2, Z2), (X2, Y2, Z1), (X2, Y1, Z2), and (X2, Y1, Z1). Referring to FIG. 4, the minimum and maximum coordinates of border points of a triangular mesh surface are (0, 0, 0) and (8, 6, 4).

In step S3, the relating module 102 obtains triangles which intersect with one of the sub-boxes from the triangular mesh surface sequentially, generates a relationship between the triangles and the intersected sub-box, and stores the relationships into the storage device 11. In one embodiment, the relating module 102 stores labels of the triangles and the label of the intersected sub-box into a same storing unit of the storage device 11 to establish the relationship between the triangles and the intersected sub-box.

In step S4, the selecting module 103 selects one of the measuring points, obtains coordinates and a searching vector of the selected measuring point. The searching vector may be directed to an X-axis direction, a Y-axis direction, or a Z-axis direction. The searching vector may also be predetermined by a user.

In step S5, the selecting module 103 determines if the searching vector of the selected measuring point can be obtained. The process as illustrated by FIG. 3B is implemented if the searching vector of the selected measuring point can be obtained.

Otherwise, the process as illustrated by FIG. 3C is implemented if the searching vector of the selected measuring point cannot be obtained.

Referring to FIG. 3B, in step S6, the first searching module 104 constructs a ray which starts from the selected measuring point along the direction where the searching vector is directed to.

In step S7, the first searching module 104 determines if the ray intersects with the enclosing box. Step S13 is implemented if the ray does not intersect with the enclosing box, step S8 is implemented if the ray does intersect with the enclosing box.

In step S8, the first searching module 104 obtains sub-boxes which intersect with the ray sequentially to generate an array of the sub-boxes.

In step S9, the first searching module 104 selects one of the sub-boxes obtained in the array sequentially.

In step S10, the first searching module 104 obtains triangles which intersect with the selected sub-box from the triangular mesh surface according to the relationships stored in the storage device 11.

In step S11, the first searching module 104 determines if the ray has an intersection point with one of the obtained triangles. Step S9 is implemented to select another one of the sub-boxes if the ray has no intersection point with any one of the obtained triangles. Otherwise, step S12 is implemented if the ray does have an intersection point with one of the obtained triangles.

In step S12, the first searching module 104 records the intersection point and a vector of the obtained triangle that has the intersection point into a measuring file.

In step S13, the determining module 106 determines if any one of the measuring points has not been selected. Step S4 in FIG. 3A is implemented if any one of the measuring points has not been selected, step S14 is implemented after all the measuring points have been selected.

In step S14, the measuring module 107 implements measurements on the surface of the object according to the measuring file.

Referring to FIG. 3C, in step S15, the second searching module 105 constructs a cubic box which is centered on the selected measuring point, and has a length of N units. N has an original value of 1. In one embodiment, the unit is millimeter.

In step S16, the second searching module 105 determines if the cubic box has an intersection area with the enclosing box. Step S15 is implemented to increase N by 1 unit until the cubic box has an intersection area with the enclosing box. Step S17 is implemented when the cubic box has an intersection area with the enclosing box.

In step S17, the second searching module 105 obtains sub-boxes in the intersection area.

In step S18, the second searching module 105 obtains triangles which intersect with the obtained sub-boxes from the triangular mesh surface according to the relationships stored in the storage device 11.

In step S19, the second searching module 105 computes distances between the selected measuring point and the midpoints of the obtained triangles, and selects a shortest distance from all the computed distances.

In step S20, the second searching module 105 records the middle point and a vector of the obtained triangle that has the shortest distance to the selected measuring point, into the measuring file. After step S20, step S13 and step S14 described in FIG. 3A are implemented to measure the surface dimension of the object according to the measuring file until all the measuring points have been selected.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for measuring surface dimension of an object, the method being executed by at least one processor of a computing device and the method comprising:
(a) loading a triangular mesh surface of a computer-aided design (CAD) model of the object and a set of measuring points selected on the CAD model from a storage device of the computing device;
(b) constructing an enclosing box of the triangular mesh surface, dividing the enclosing box into a plurality of sub-boxes, and labeling each of the sub-boxes;
(c) obtaining the triangles which intersect with one of the sub-boxes from the triangular mesh surface sequentially, generating a relationship between the triangles and the intersected sub-box, and storing the relationships into the storage device;
(d) selecting one of the measuring points, and obtaining coordinates and a searching vector of the selected measuring point;
(e) constructing a ray which starts from the selected measuring point and along the direction where the searching vector is directed to;
(f) obtaining sub-boxes which intersect with the ray sequentially to generate an array of the sub-boxes;
(g) selecting one of the obtained sub-boxes in the array one by one, and obtaining triangles which intersect with the selected sub-box from the triangular mesh surface according to the relationships stored in the storage device;
(h) repeating step (g) until the ray has an intersection point with one of the obtained triangles;
(i) recording the intersection point and a vector of the obtained triangle that has the intersection point into a measuring file;
(j) repeating step (d) to step (j) until all the measuring points have been selected; and
(k) implementing measurements on the surface of the object according to the measuring file.

2. The method according to claim 1, wherein step (b) comprises:
obtaining minimum coordinates (X1, Y1, Z1) and maximum coordinates (X2, Y2, Z2) of border points of the triangular mesh surface, and constructing the enclosing box using vertexes which respectively have coordinates of (X1, Y1, Z1), (X1, Y1, Z2), (X1, Y2, Z1), (X1, Y2, Z2), (X2, Y2, Z2), (X2, Y2, Z1), (X2, Y1, Z2), and (X2, Y1, Z1).

3. The method according to claim 1, wherein a number of the sub-boxes is equal to a number of the triangles in the triangular mesh surface.

4. The method according to claim 1, wherein the searching vector is directed to an X-axis direction, a Y-axis direction, or a Z-axis direction.

5. A computerized method for measuring surface dimension of an object, the method being executed by at least one processor of a computing device and the method comprising:
(a) loading a triangular mesh surface of a computer-aided design (CAD) model of the object and a set of measuring points selected on the CAD model from a storage device of the computing device;
(b) constructing an enclosing box of the triangular mesh surface, dividing the enclosing box into a plurality of sub-boxes, and labeling each of the sub-boxes;
(c) obtaining the triangles which intersect with one of the sub-boxes from the triangular mesh surface sequentially, generating a relationship between the triangles and the intersected sub-box, and storing the relationships into the storage device;
(d) selecting one of the measuring points, and obtaining coordinates of the selected measuring point;
(e) constructing a cubic box which is centered as the selected measuring point and has a length of N units;
(f) repeating step (e) until the cubic box has an intersection area with the enclosing box;
(g) obtaining sub-boxes in the intersection area, and obtaining triangles which intersect with the obtained sub-boxes from the triangular mesh surface according to the relationships stored in the storage device;
(h) computing distances between the selected measuring point and the middle points of the obtained triangles, and selecting a shortest distance from the computed distances;
(i) recording the middle point and a vector of the obtained triangle that has the shortest distance to the selected measuring point into the measuring file;
(j) repeating step (d) to step (j) until all the measuring points have been selected; and
(k) implementing measurements on the surface of the object according to the measuring file.

6. The method according to claim 5, wherein step (b) comprises:
obtaining minimum coordinates (X1, Y1, Z1) and maximum coordinates (X2, Y2, Z2) of border points of the triangular mesh surface, and constructing the enclosing box using vertexes which respectively have coordinates of (X1, Y1, Z1), (X1, Y1, Z2), (X1, Y2, Z1), (X1, Y2, Z2), (X2, Y2, Z2), (X2, Y2, Z1), (X2, Y1, Z2), and (X2, Y1, Z1).

7. The method according to claim 5, wherein number of the sub-boxes is equal to a number of the triangles in the triangular mesh surface.

8. The method according to claim 1, wherein N has an original value of 1, and is increased by 1 unit each time.

9. A computing device, comprising:
a storage device;
at least one processor; and
one or more modules that are stored in the storage device, and are executed by the at least one processor, the one or more modules comprising instructions to:
load a triangular mesh surface of a computer-aided design (CAD) model of the object and a set of measuring points selected on the CAD model from the storage device, construct an enclosing box of the triangular mesh surface, divide the enclosing box into a plurality of sub-boxes, and label each of the sub-boxes, obtain the triangles which intersect with one of the sub-boxes from the triangular mesh surface sequentially, generate a relationship between the triangles and the intersected sub-box, store the relationships into the storage device, and select one of the measuring points;
when a searching vector of the selected measuring point can be obtained, the one or more modules further comprising instructions to:
obtain coordinates and the searching vector of the selected measuring point, construct a ray which starts from the selected measuring point and along a direction where the searching vector is directed to, obtain sub-boxes which intersect with the ray sequentially to generate an array of the sub-boxes, select one of the obtained sub-boxes in the array one by one, obtain triangles which intersect with the selected sub-box from the triangular mesh surface according to the relationships stored in the storage device, record an intersection point of the ray and one of the obtained triangles and a vector of the obtained triangle into a measuring file, and implement measurements on the surface of the object according to the measuring file.

10. The computing device according to claim 9, when a searching vector of the selected measuring point cannot be obtained, the one or more modules comprising instructions to:
obtain coordinates of the selected measuring point, construct a cubic box which is centered as the selected measuring point, and has a length of N units, obtain sub-boxes in an intersection area of the cubic box and the enclosing box, obtain triangles which intersect with the obtained sub-boxes from the triangular mesh surface according to the relationships stored in the storage device, compute distances between the selected measuring point and the middle points of the obtained triangles, select a shortest distance from the computed distances, record the middle point and a vector of the obtained triangle that has the shortest distance to the selected measuring point into a measuring file, and implement measurements on the surface of the object according to the measuring file.

11. The computing device according to claim 9, wherein the one or more modules further comprise instructions to construct the enclosing box to:
obtain minimum coordinates (X1, Y1, Z1) and maximum coordinates (X2, Y2, Z2) of border points of the triangular mesh surface, and construct the enclosing box using vertexes which respectively have coordinates of (X1, Y1, Z1), (X1, Y1, Z2), (X1, Y2, Z1), (X1, Y2, Z2), (X2, Y2, Z2), (X2, Y2, Z1), (X2, Y1, Z2), and (X2, Y1, Z1).

12. The computing device according to claim 9, wherein a number of the sub-boxes is equal to a number of the triangles in the triangular mesh surface.

13. The computing device according to claim 9, wherein the searching vector is directed to an X-axis direction, a Y-axis direction, or a Z-axis direction.

14. The computing device according to claim 10, wherein N has an original value of 1, and is increased by 1 unit each time.
